(19) United States
(12) Patent Application Publication
(10) Pub. No.: US 2004/0128443 A1
(43) Pub. Date: Jul. 1, 2004

(54) Data storage system, data storage apparatus, computers and programs

(76) Inventors: Yasunori Kaneda, Sagamihara (JP); Ayumi Mikuma, Kawasaki (JP)

Correspondence Address: MATTINGLY, STANGER & MALUR, P.C., SUITE 370, 1800 DIAGONAL ROAD, ALEXANDRIA, VA, 22314, US

(21) Appl. No.: 10/720,308

(22) Filed: Nov. 25, 2003

(30) Foreign Application Priority Data
Nov. 28, 2002 (JP) 2002-344812

(51) Int. Cl. G06F 12/00

(52) U.S. Cl. 711/114; 711/202

(57) ABSTRACT

In a disk array apparatus, it had taken a very long time for a computer to recognize several thousand volumes, and most memory had been occupied [in the process]. Further, volume recognizing and splitting processes could not be easily carried out.

In a first embodiment of the present invention, a data storage apparatus has a management unit for sending to the computer a response for recognizing a virtual drive unit capable of treating the storage volume that is non-removable as a removable storage medium, and a storing unit for storing volume management information indicating the correspondent relationship between a virtual drive unit and a storage volume. The computer has an interface for receiving a response, and a management unit for recognizing, on the basis of the response, a virtual drive unit capable of treating the storage volume that is non-removable as a removable storage medium. The management unit of the data storage apparatus specifies a storage volume to be accessed on the basis of an access request from the computer to the virtual drive unit, and the volume management information.

### BACKGROUND OF THE INVENTION

1. Field of the Invention

The present invention relates to a method for managing and controlling storage volumes in a data storage apparatus, and more particularly, to a method for managing and controlling volumes in a large-scale data storage apparatus typified by a disk array apparatus, when the data storage apparatus maintains a large number of storage volumes.

2. Description of the Related Art

In recent years, disk array apparatus have come to be used the most as data storage apparatus for holding the programs and data used by computers.

A disk array apparatus combines a plurality of hard disk drives to achieve a high-performance, highly reliable data storage apparatus. Viewed from the host computer, the plurality of hard disk drives of a disk array apparatus can be operated as a single logical storage volume. [This storage volume] can also be partitioned into volumes of arbitrary sizes, and a number of volumes can also be combined and treated as an even larger volume. In line with the realization of larger capacity hard disk drives, a single disk array apparatus can now be operated as several thousand volumes. For example, there is “The Windows NT Device Driver Book” (written by Art Baker) that deals with volume recognition methods for OS (operating systems).

Even though disk array apparatus have come to be treated as comprising several thousand volumes, problems arise when several thousand volumes are connected to a single computer. In general, a computer OS carries out recognition processing for all volumes connected to the computer at start up. A volume recognition process first detects the interface boards (generally fibre channel boards or SCSI boards) connected to the computer, and then verifies volume capacity via a “READ CAPACITY command,” which [reads] the types and vendor names of the connected volumes by issuing an “INQUIRY command” while incrementing the identification numbers (in the case of SCSI, a target number and a logical unit number) for these interface boards. This volume detecting process is carried out for all interface boards connected to the computer. When the OS receives an appropriate response from a volume, it prepares information on this volume, and stores [this information] in computer memory. The information prepared at this point is referenced thereafter to access this volume.

When several thousand volumes are connected to a single computer, not only does it take time for the computer to detect the several thousand volumes at start-up, but the information for managing several thousand volumes occupies memory.

Further, a system configuration, called a Storage Area Network (SAN), which connects storage and computers via a network, has come into use. In a SAN, a plurality of data storage apparatus and a plurality of computers are connected over a fibre channel or Ethernet (“Ethernet” is a registered trademark of the Fuji Xerox Corporation. The same shall apply hereinafter.) network. In a SAN, it is particularly desirable that the correspondent relationship of a computer and a volume be capable of being easily changed to coincide with processing.

### SUMMARY OF THE INVENTION

With the foregoing in view, it is an object of the present invention to provide, in a data storage system having a data storage apparatus and a computer, a constitution, a program and a method for achieving a data storage apparatus (or a group of data storage apparatus in a SAN) having several thousand volumes.

To achieve an object of the present invention, a data storage system of a first embodiment of the present invention has computers, a data storage apparatus having a plurality of storage volumes for storing data to be accessed by the computers, and a management computer for managing the computers and the data storage apparatus. The data storage apparatus has a management unit for carrying out emulation for recognizing a virtual drive unit capable of treating a non-removable data storage apparatus as a removable data storage medium, and a storing unit for storing volume management information indicating the correspondent relationship between the virtual drive unit and the data storage apparatus. Further, a computer has an interface for receiving a response, and a management unit for recognizing a virtual drive unit for treating a non-removable data storage apparatus as a removable data storage medium based on a response. Furthermore, the management unit of the data storage apparatus specifies a storage volume to be accessed based on an access request from the computer to the virtual drive unit, and volume management information.

The management unit of a computer of the above-described embodiment can also recognize a storage volume accessed by the virtual drive unit as a real non-removable storage volume.

The management unit of the data storage apparatus of the above-described embodiment can receive a switching request from a computer for switching the correspondent relationship between the virtual drive unit and the storage volume, and based on the switching request, can rewrite volume management information.

The management unit of a computer of the above-described embodiment can send, based on a response, file system type information of the recognized virtual drive unit to the management computer.

The management unit of the data storage apparatus of the above-described embodiment can send, based on a response, file system type information of the recognized virtual drive unit to the management computer.

The storing unit of the data storage apparatus of the above-described embodiment can also store, as volume management information, replication information for replicating data stored in a first storage volume to a second storage volume of the storage volumes, and the management unit of the data storage apparatus, based on the replication information, can replicate the data stored in the first storage volume to the second storage volume of the storage volumes, and when a request to retrieve the first storage volume from the virtual drive unit is issued by the computer, [the management unit] can terminate replication of data to be stored in the first storage volume to the second storage volume. This enables the second storage volume to be treated as a replicated storage volume at the time at which the first storage volume splits from the virtual drive unit.

### BRIEF DESCRIPTION OF THE DRAWINGS

FIG. 1 is a diagram of a computer system showing an embodiment of the present invention;

FIG. 2 is a diagram showing the hardware configuration of a disk array apparatus;

FIG. 3 is a diagram showing the software configuration of a computer;

FIG. 4 is a diagram showing the constitution of a volume management table;

FIG. 5 is a diagram showing the constitution of a setup screen;

FIG. 6 is a diagram showing a flowchart of a loading process;

FIG. 7 is a diagram showing a flowchart of a splitting process;

FIG. 8 is a diagram showing a flowchart of a replicated volume splitting process;

FIG. 9 is a diagram showing a flowchart of a replicated volume splitting process;

FIG. 10 is a diagram of a computer system showing an embodiment of the present invention using a virtual volume changer device; and

FIG. 11 is a block diagram of the computers and the management computer.

### DESCRIPTION OF THE PREFERRED EMBODIMENTS

System Configuration

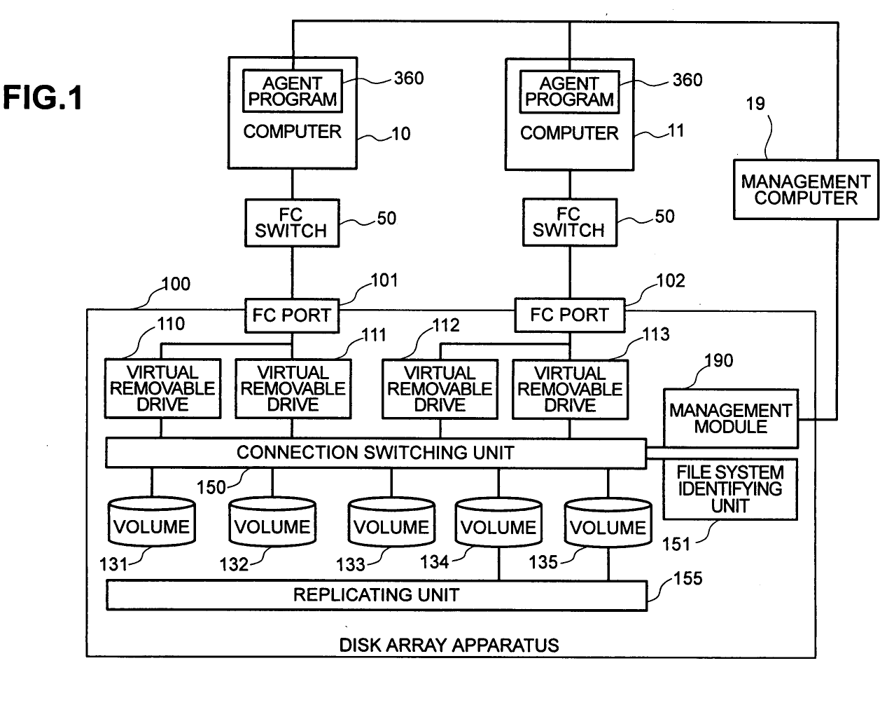

FIG. 1 shows a system configuration of an embodiment of the present invention.

In the system configuration of FIG. 1, computers 10, 11 are connected to disk array apparatus 100 via fibre channel switches 50 (hereinafter referred to as FC switches 50). The FC switches 50 are connected between the respective apparatus using fibre channels. In this embodiment, the computers and disk array apparatus are connected using fibre channels, but [these apparatus] can be connected using a LAN, for example, an Ethernet.

FC ports 101, 102 are disposed in the disk array apparatus 100 as connection ports for connecting the FC switches 50. Virtual removable drives 110 through 113 are provided virtually by managing a volume management table 400, which will be described hereinbelow, for each computer, and virtual removable drives 110 and 111 are connected to computer 10 via FC port 101, and virtual removable drives 112 and 113 are connected to computer 11 via FC port 102.

Connection switching unit 150 switches the correspondent relationships of volumes 131 through 135 and virtual removable drives 110 through 113 in accordance with the contents of the volume management table 400, which will be described hereinbelow.

Furthermore, in this embodiment, as long as there is one or more, there are no limits of any sort on the number of FC ports, virtual removable drives, volumes and disk array apparatus.

A management computer 19 is connected to the computers 10, 11 and the disk array apparatus 100 via an Ethernet or other such LAN.

The management computer 19 communicates with agent programs 360 on computers 10 and 11. Further, the management computer 19 communicates with a management module 190 of the disk array apparatus 100.

It is supposed that an administrator will monitor the status of the computer system and implement required operations via the management computer 19.

Disk Array Apparatus

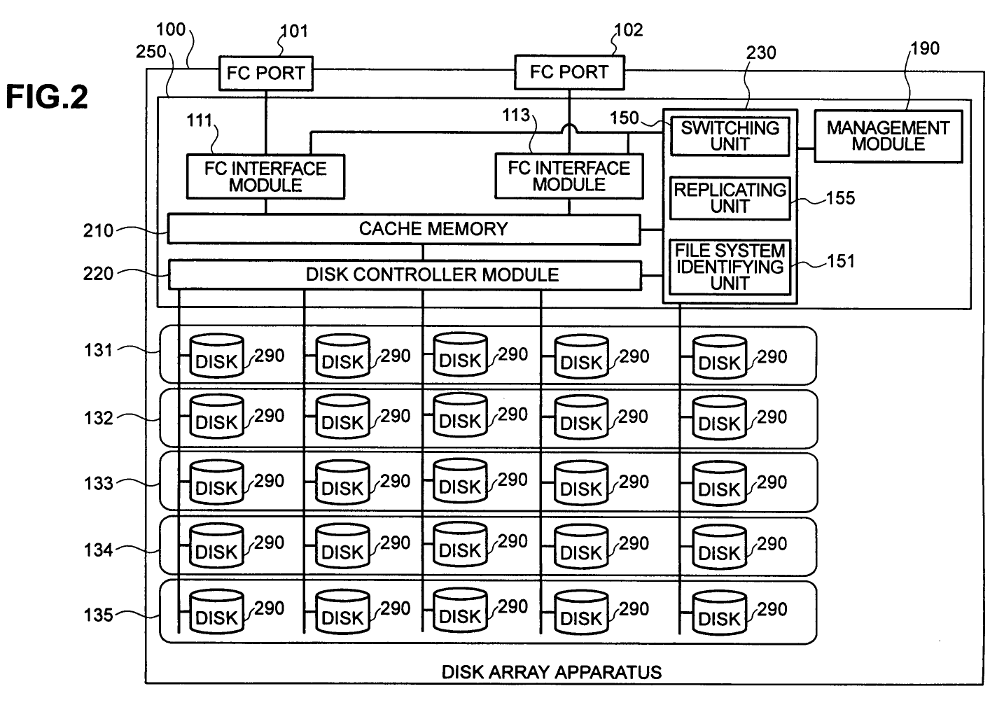

FIG. 2 shows a physical block diagram of the disk array apparatus 100.

The disk array apparatus 100 is a data storage apparatus constituting FC ports 101, 102, which are connection ports connected to FC switches 50, hard disk drives 290, and a management unit 250.

The disk array apparatus 100 has the management unit 250 for generating a response to the computer 10, 11 for recognizing a virtual removable drive capable of treating a storage volume of a non-removable hard disk drive 290 as a removable hard disk drive.

The management unit 250 manages access to data stored in a plurality of storage volumes 61 that exist in the disk array apparatus 100, by receiving an access request from a computer 10, 11 to a virtual removable drive, and specifying a storage volume of a hard disk drive 290 to be accessed based on the access request and the volume management table 400.

Further, in the case of this embodiment, [the management unit 250] is connected to 25 hard disk drives 290 via a disk controller module 220.

The management unit 250 has FC interface modules 111, 113, which are interfaces for connecting to the computers 10, 11 via the FC ports 101, 102; a cache memory 210, which is a storing unit for temporarily storing data and commands received from the computers, and data read out from hard disk drives 290; a disk controller module 220 for connecting the hard disk drives 290; an array controller 230 for controlling the FC interface modules 111, 113, cache memory 210, and disk controller module 220, and for managing array control; and a management module 190 for communicating with the management computer 19.

The array controller 230 manages the correspondent relationships between the hard disk drives 290 and the logical volumes 131 through 135. In this embodiment, the connected 25 hard disk drives 290 constitute five logical volumes [comprising] sets of five hard disk drives 290.

The cache memory 210 stores the volume management table 400, which indicates the correspondent relationships between the virtual removable drives and the storage volumes of the hard disk drives 290.

A hard disk drive 290 is a storage volume for storing data to be accessed by the computers 10, 11, and is a non-removable storage volume in which disks cannot be removed from the drive. Furthermore, the storage volume of a hard disk drive 290 is treated as a logical unit volume by the array controller. The storage volume of a hard disk drive 290 can also constitute a plurality [of volumes].

The virtual removable drives 110 through 113, the connection switching unit 150, the replicating unit 155 and the virtual volume changer devices 118, 119 are realized as management programs executed by the array controller 230.

Constitutions of Computers and Management Computer

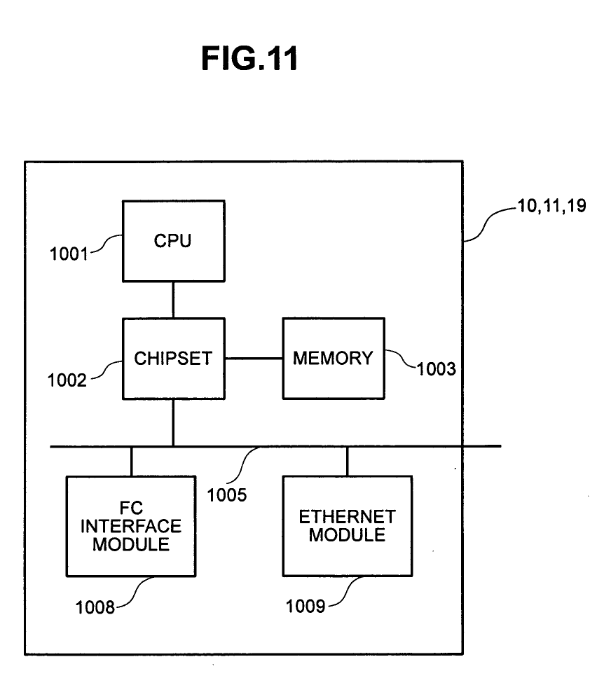

FIG. 11 is a diagram showing the constitutions of computers 10, 11 and the management computer 19. Computers 10, 11 and the management computer 19 constitute a CPU (management unit) 1001; memory 1003 for storing programs to be executed by the CPU 1001, and the data required at the time of such execution; a chipset 1002 for mediating the exchange of data between the CPU 1001, memory 1003 and a bus 1005; and an FC interface module 1008 and Ethernet module 1009 connected to the bus 1005. As shown in FIG. 1, the computers 10, 11 are connected to the disk array apparatus 100 from the FC interface modules 1008 via the FC switches 50. Further, the agent programs 360 on the computers 10, 11 are connected to the management computer via the Ethernet module 1009.

Configuration of Computer Software Modules

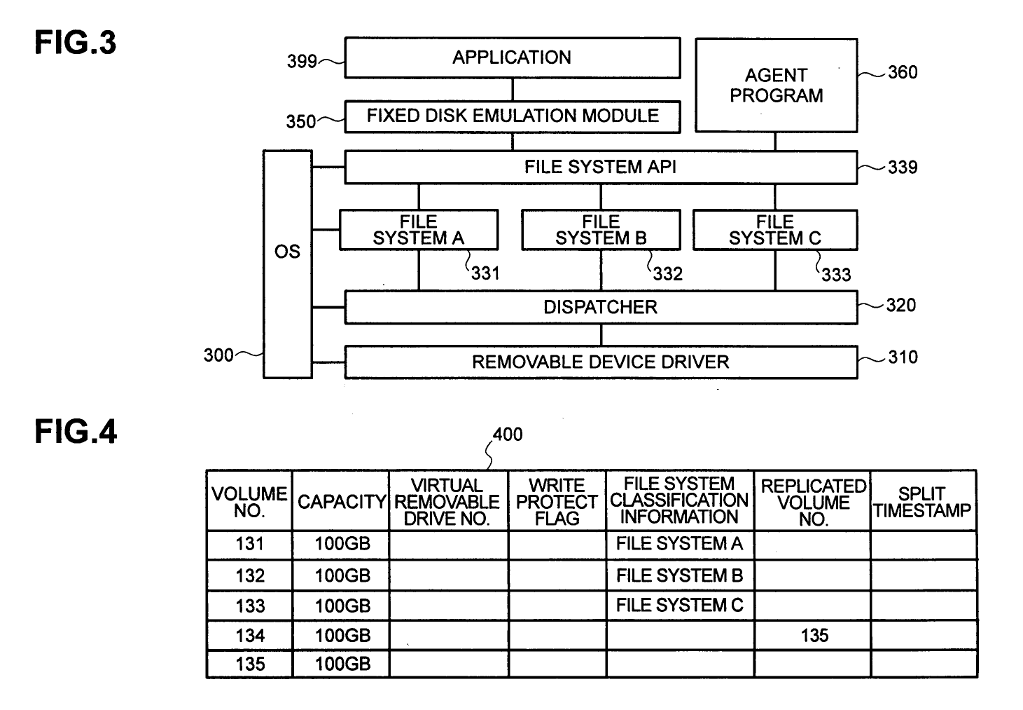

FIG. 3 is a diagram showing the software modules of the computers 10, 11.

These software modules 300, 310, 320, 331, 332, 333, 339, 360, 399 are programs stored in the memories 1003 and executed by the CPUs 1001 of the computers 10, 11.

Managing Volumes

FIG. 4 shows the contents of volume management table 400 showing the relationships between virtual removable drives and volumes.

The volume management table 400 has information indicating each volume number, the capacity of each volume, the number of the virtual removable drive into which each volume is virtually loaded (A single volume can support a plurality of virtual removable drives.), a write protect flag for each volume, information indicating the type of the file system of each volume, a secondary volume number for a replicated volume, which will be described hereinbelow, and a split timestamp for when a secondary volume is split. Furthermore, volume numbers are allocated such that there is no duplication of numbers inside the disk array apparatus. Here, for the sake of simplicity, the numbers in FIG. 1 will be described as-is as the volume numbers 131 through 135. Further, the virtual removable drive numbers are also allocated such that there is no duplication of numbers inside the disk array apparatus. Similarly, the numbers in FIG. 1 will be described as-is as the virtual removable drive numbers 110 through 113.

Further, immediately following the start up of the disk array apparatus 100, the field for “virtual removable drive no.” in the volume management table 400 is set to blank (NULL) as the initialization value. This signifies that the virtual removable drives have not been virtually loaded in the volumes.

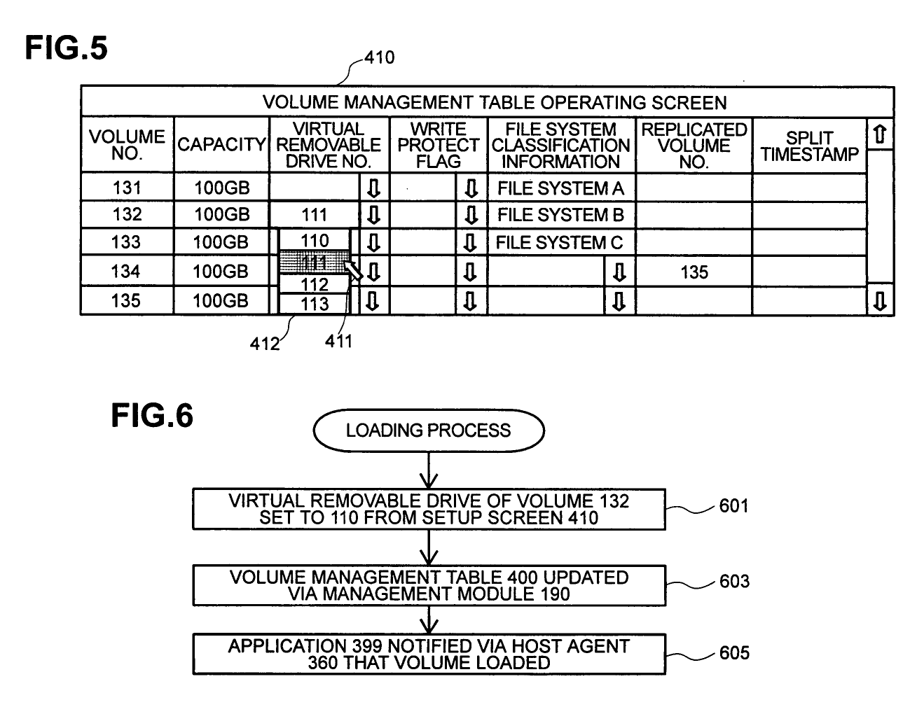

FIG. 5 shows the contents of a setup screen 410 displayed on the displaying means (display not shown in the figure) of the management computer 19.

The management computer 19 collects the information of the volume management table 400 inside the array controller 230 via the management module 190, and displays the contents of the volume management table 400 on the setup screen 410.

An administrator can input the contents of the volume management table 400 via this setup screen 410 using a mouse or other such GUI.

The display example of FIG. 5 is an image of selecting a virtual removable drive in which to load a volume 132 using a mouse cursor 411. A virtual removable drive number displayed in a pull-down menu 412 can be selected using the mouse cursor 411.

The management computer 19 instructs the array computer 230 to set and change the contents of the volume management table 400 based on the information inputted by the mouse or other such GUI.

The array controller 230 sets and changes the contents of the volume management table 400 based on instructions from the management computer 19.

Recognition Process of Disk Array Apparatus

The operation when a computer has been started up will be described. Furthermore, as shown in FIG. 1, it is supposed that the computer is connected to a disk array apparatus that has already been started up.

When a computer is started up, the computer searches for devices that are connected to the computer, and recognizes the disk array apparatus 100.

The computer issues a verification command (for example, an INQUIRY command) to the recognized disk array apparatus 100 for verifying the types of the storage volumes connected to the computers 10, 11.

In response to the verification command, the disk array apparatus 100 sends a reply to the computers 10, 11 [citing] the types of the devices (whether they are magnetic disk drives, or optical disk drives, and whether the disks are removable or fixed), the device names, vendor names, and so forth.

A conventional disk array apparatus will reply with information indicating “magnetic disk drive; fixed disk” as the device type if the disk drives connected internally are hard disk drives 290. For example, in a disk array apparatus that uses an FC channel, since SCSI commands are used in most cases, the first byte of the data string of the reply to the INQUIRY command “00H (one hexadecimal byte)” will correspond to this.

The disk array apparatus 100 of this embodiment is constituted such that, when the array controller 230 receives a verification command from a host computer via an FC interface module 111, 113, the reply “magnetic disk drives; removable disks” is sent as the device type. For example, the first byte of this reply data string to the INQUIRY command becomes “80H (one hexadecimal byte)”.

The computers 10, 11 load the removable device driver 310 corresponding to the device type based on the reply information from the disk array apparatus 100.

Ordinarily, a dispatcher 320 for switching file systems is disposed on top of this removable device driver 310, and a plurality of file systems 331 through 333 are loaded. Thus, a different plurality of file systems can be used for each computer. This embodiment will be described as computer 10 being able to use file system A331 and file system B332, and computer 11 being able to use file system A331 and file system C333.

File system API 339 is an interface for using the appropriate file system 331 through 333 for accessing hard disk drives 290 from application 399. In accordance therewith, access to storage volumes from application 399 can be carried out via a fixed procedure regardless of differences in the file systems.

Therefore, by virtue of the disk array apparatus instructing a host computer such that a fixed disk drive is recognized as a drive that treats the disk as being removable, the host computer can load a driver for the fixed disk that treats the disk as being removable. Thus, the host computer can recognize a non-removable (fixed) hard disk drive 290 as a virtual removable drive capable of treating a storage volume as a removable disk. Accordingly, since the host computer can recognize devices in drive units, the resources accompanying the device recognition process can be held in check, especially when there is an extremely large number of volumes.

In addition, in this embodiment of the present invention, a fixed disk emulation module 350 is disposed between the file system API 339 and application 399. If this module is not provided, the disk array apparatus 100 will be recognized as a removable drive by the application 399 using a storage volume via the file system API 339. Applications that use a disk array apparatus include databases and the like, but ordinarily, these applications are prohibited from being constructed on removable drives.

Accordingly, the fixed disk emulation module 350 sends the reply “magnetic disk drive; fixed disk” to the file system when a device type identification request has been generated. Therefore, by making it possible for application 399 to recognize a volume connected to a virtual removable drive of the disk array apparatus 100 as its actual type of “magnetic disk drive; fixed disk,” it is possible to prevent invalid utilization restrictions that can occur as a result of creating a virtual drive for application 399. The OS does not automatically load the fixed disk emulation module 350. This is because the array controller 230 replies “80H” via an INQUIRY command with respect to a type check from a computer, and, based on this information alone, it is not possible to determine whether or not this device is a virtual removable data storage apparatus. In general, the administrator managing the computers 10, 11 will load the fixed disk emulation module 350 in line with executing an application so that the above-mentioned utilization restrictions are not placed on the application. Further, to automate the loading process, [the present invention] is constituted such that the fixed disk emulation module 350 is loaded when device names and vendor names are acquired from within the data string that the INQUIRY command returns, and there exists a specific device name and vendor name. This can be achieved by modifying the OS, and it can also be achieved by providing this function in the application or agent program.

Description of Processes

Each process in the present invention will be described. Here, the description supposes a state in which volume 131 is formatted for file system A, volume 132 is formatted for file system B, and volume 133 is formatted for file system C, and [these volumes] have been initialized beforehand. It is supposed that volumes 134 and 135 are in a state of disuse.

Loading Process

FIG. 6 is a flowchart of the volume loading process.

The management computer 19 receives instructions via the setup screen 410 for loading volume 132 onto a virtual removable drive, and passes the received loading instructions on to the disk array apparatus 100 (601).

When the array controller 230 of the disk array apparatus 100 receives the volume loading instructions, it updates and sets the volume management table 400 by way of the management module 190 in accordance with the instructions (603). In other words, the disk array apparatus 100, in accordance with the volume loading instructions, sets volume 132 of the volume management table 400 to either virtual removable drive “110” or “111” loaded onto computer 10. It is supposed here that. “110” has been set. Next, the management computer 19 notifies application 399 by way of the host agent 360 on the computer 10 that volume 132 has been loaded onto virtual removable drive “110” (605).

In accordance therewith, the array controller 230 can access volume 132 of virtual removable drive 110 on the basis of volume management table 400 and an access (read-write processing) request resulting from executing application 399. Here, since volume 132 has been initialized in the format for file system B, volume 132 is accessed using file system B332.

Ejecting Process (Volume Splitting)

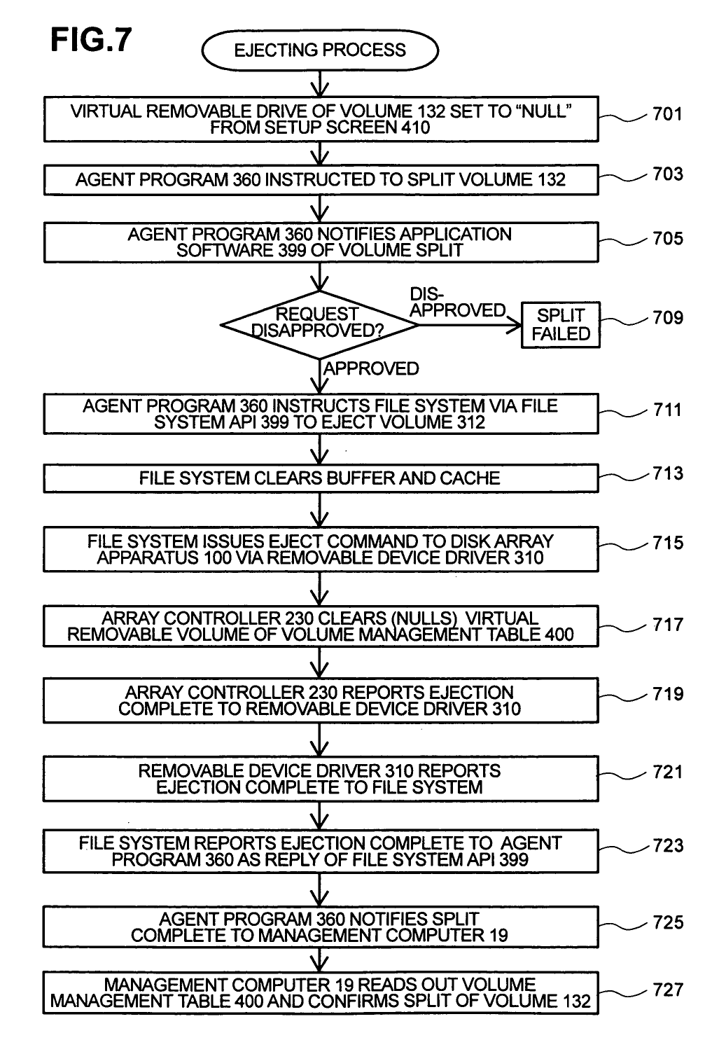

FIG. 7 is a flowchart of the volume ejecting process (volume splitting).

The management computer 19 receives instructions from the setup screen 410 for ejecting volume 132. That is, the management computer 19 receives instructions via the setup screen 410 for nullifying the relationship between volume 132 and the virtual removable drive (701).

The management computer 19 instructs the agent program 360 on computer 10 to split volume 132 from the virtual removable drive (703).

The agent program 360 notifies application 399 that the volume is to be split (705).

If the application 399 refuses this request, the agent program 360 notifies the management computer 19 to this effect, and splitting fails (709).

When the application 399 approves the split, the agent program 360 instructs the file system via the file system API399 to eject volume 132 (711).

When the file system receives the eject request, it clears all of the data inside the buffer and cache memories that the file system has (713), and issues an eject command (in SCSI, a bit for ejecting is set in the START STOP UNIT command) to the disk array apparatus 100 via the removable device driver 310 (715).

When the array controller 230 of the disk array apparatus 100 receives an eject command via the FC interface module 111, 113, it clears (for example, it inputs NULL) the virtual removable volume of the volume management table 400 corresponding to volume 132 (717). In accordance therewith, the correspondent relationship between volume 132 and virtual removable drive 110 disappears from the volume management table 400.

When the virtual removable volume is cleared from volume management table 400, the array controller 230 reports to the removable device driver 310 of computer 10 that ejection has been completed (719).

Upon receiving [the report] that ejection is complete, the removable device driver 310 reports to the file system that ejection is complete (721).

When the file system receives [the report] that ejection is complete, it reports that ejection is complete to the agent program 360 as a reply to file system API399 (723).

The agent program 360 notifies the management computer 19 that splitting is complete (725).

Upon receiving the notification that splitting is complete, the management computer 19 reads out the volume management table 400 via the management module 190, and confirms that volume 132 has been split (727).

As described hereinabove, in this embodiment of the present invention, a volume can be easily ejected by simply rewriting the volume management table 400 of the disk array apparatus 100. Thus, it becomes impossible for application 399 to access volume 132 of virtual removable drive 110.

Therefore, the array controller of the disk array apparatus provides a volume management table for indicating the correspondent relationship between drives and volumes, and the array controller can specify a volume to be accessed based on the volume management table and an access request to a drive from a host computer. Accordingly, a volume of a fixed disk apparatus can easily be changed from computer 10 to [computer] 11 by simply rewriting the volume management table 400 of the disk array apparatus 100.

Also, for example, when volume 133 is loaded onto virtual removable drive 110, which is loaded onto computer 10, volume changing can be done easily in the volume management table 400 by ejecting volume 133 from virtual removable drive 110 of computer 10, and loading volume 133 to virtual removable drives 112, 113 of computer 11, making it possible for computer 11 to use volume 133, which [heretofore] computer 10 had been able to use.

Registering File System Types in Volume Management Table 400

The management computer 19 receives a request via a GUI to search for file system types.

When the agent program 360 receives the file system type search request, it acquires, via file system API399, information of the file systems of currently loaded volumes.

Next, the agent program 360 calls up a removable device driver, and issues to the disk array apparatus 100 a verification command for the type of each currently loaded volume (for example, an INQUIRY command).

The disk array apparatus 100 returns the volume number of each volume based on the verification command.

This enables the agent program 360 to acquire the volume numbers of each currently loaded volume.

Therefore, the agent program 360 can reply to the management computer 19 with the volume numbers and file system type information of each currently loaded volume.

The management computer 19, based on the received information, sets and registers the file system type information of each volume in the volume management table 400.

Using File System Type Information

When the agent program 360 receives a request for notification of usable file system types from the management computer 19, it returns usable file system type information.

Accordingly, the management computer 19 acquires usable file system type information in computers 10 and 11 from the agent programs 360. In the case of this embodiment, file system A and file system B are reported from computer 10, and file system A and file system C are reported from computer 11.

A usable computer can be specified for each volume based on the usable file system type information of each of these computers, and volume management table 400 information. More specifically, the fact that computers 10 and 11 are capable of using volume 131, only computer 10 is capable of using volume 132, and only computer 11 is capable of using volume 133 can be easily specified.

Accordingly, for a computer for which the volume format and file system capable of being used by the computer do not match up on the setup screen 410, and which cannot use a volume specified by the volume management table 400 even though it has been loaded, a process for deterring a loading process for a volume specified in the volume management table 400 can be provided.

Double Loading

Since volume 131 is formatted for file system A, computers 10 and 11 can use it.

When volume 131 is already being used by computer 10, even if the management computer 19 instructs that volume 131 be loaded onto virtual removable drive 112, the load request fails because [volume 131] is already being used.

However, [the present invention] can be constituted such that volume 131 is allowed to be utilized simultaneously in computers 10 and 11 if a write protect flag is set for volume 131 beforehand from the management computer 19. This is because there are no problems whatsoever with volume 131 being used by a plurality of computers so long as they do not write to volume 131.

Furthermore, when volume 131 is loaded into two computers, the write protect flag cannot be cleared from the setup screen 410.

Replicated Volume

Replicated volumes (duplicate volumes) refer to two different volumes onto which exactly the same data strings have been recorded. The description given here supposes that volumes 134 and 135 are replicated volumes. A primary-secondary relationship exists between replicated volumes, and in this embodiment, volume 134 is treated as the primary [volume], and volume 135 is treated as the secondary [volume].

The management computer 19 receives specifications for the volume number and replicated volume number via a GUI, and instructs these specifications to the array controller 230. For example, it is supposed that the replicated volume number for volume 134 is “135”.

The array controller 230, in accordance with the instructions, sets “135” in the volume management table 400 as the replicated volume number for volume 134.

Accordingly, the replicating unit 155 connects volume 134 and volume 135, and a data write generated for volume 134 is carried out in synchronized fashion to volume 135 as well.

Loading Process for Uninitialized Volumes

The loading process for volumes 134, 135, which have not been initialized in computers 10 or 11, will be described.

The management computer 19 receives instructions via a GUI to load volume 134 onto a virtual removable drive.

Upon receiving the loading instructions, disk array apparatus 100 updates and sets the volume management table 400 by way of the management module 190 in accordance with the instructions. At this point, the disk array apparatus 100 changes and sets volume 134 to either virtual removable drive “110” or “111” in the volume management table 400. It is supposed that [volume 134] was changed and set to “110” here.

Now, since volume 134 is an uninitialized state, the management computer 19 receives a desired file system type specification via the GUI. It is supposed that “file system A” was specified here.

The management computer 19, in accordance with the received file system type specification, issues instructions via the management module 190 such that [this specification] is updated and set in the volume management table 400.

The array controller 230 of the disk array apparatus 100 updates and sets the volume management table 400 in accordance with the instructions.

Meanwhile, the management computer 19 instructs the host agent 360 to initialize volume 134 in the file system A format.

The host agent 360 carries out initialization for volume 134 in the file system A format via file system API399.

The host agent 360 reports to management computer 19 that file system formatting is complete.

Upon receiving the report that formatting is complete, the management computer 19 notifies application 399 via the host agent 360 on computer. 10 that volume 134 has been loaded.

Accordingly, it becomes possible for the array controller 230 to access the initialized volume 134 of virtual removable drive 110 on the basis of the volume management table 400, and an access request from application 399. Furthermore, since volume 134 has been initialized in the file system A format, volume 134 is accessed using file system A331. Also, since a data string that is exactly the same as that of volume 134 has been generated for volume 135, which is set as the secondary [volume] of volume 134, volume 135 is also initialized in the file system A format.

Replicated Volumes: Purpose and Problems

Next, the process for splitting the primary-secondary relationship of replicated volumes will be described.

For example, if primary volume 134 and secondary volume 135 are split at a certain time T, the secondary volume is a duplicate of volume 134 at time T, and can be used as a backup at time T. In this splitting process, the termination of the status of the volumes as file systems is a prerequisite. That is, when data that has not been written into the volumes remains inside the buffer and cache memories of a file system, [volume 134] cannot be used as a backup at time T.

Splitting the Primary and Secondary [Volumes]

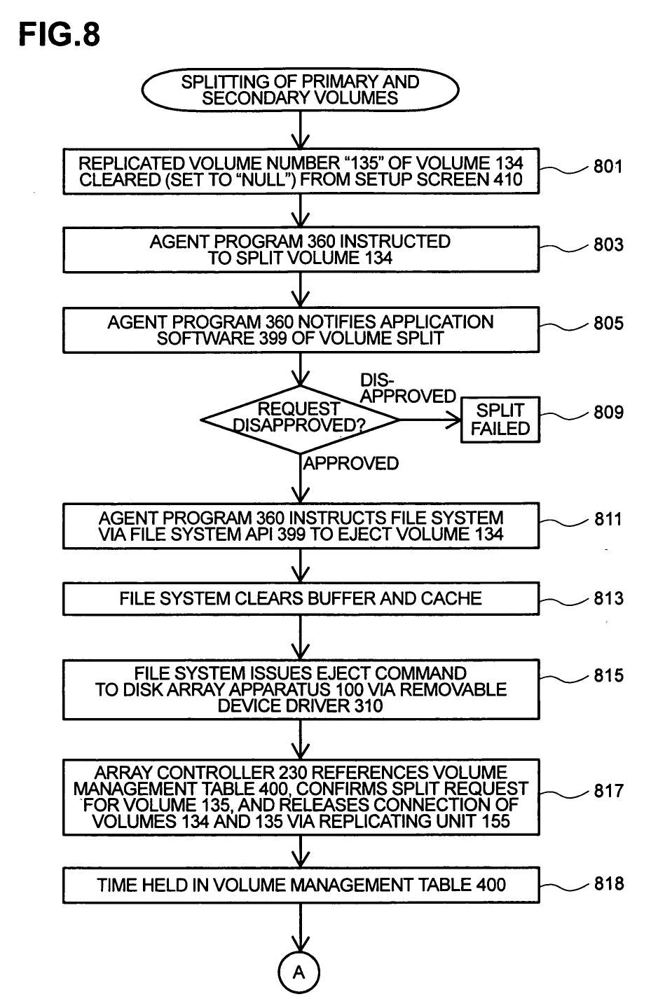

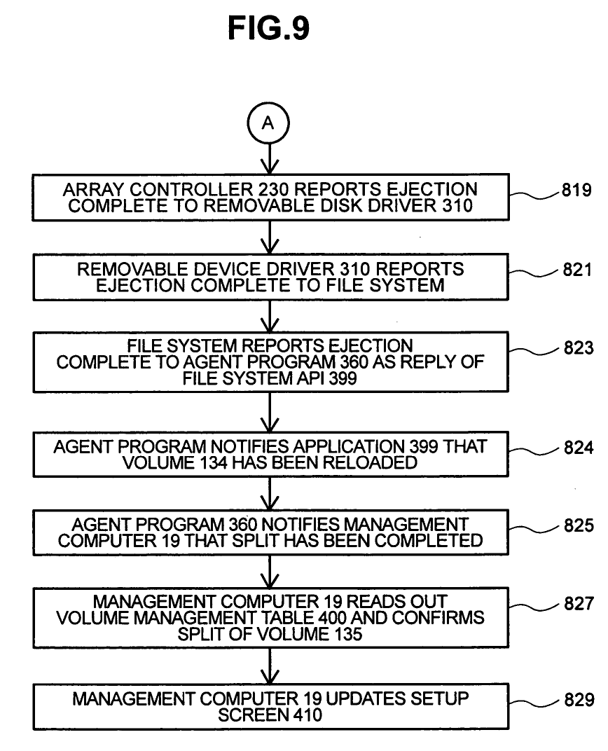

FIG. 8 and FIG. 9 are flowcharts for describing the primary-secondary splitting process for replicated volumes.

First, the management computer 19 receives a request via a GUI to split the primary and secondary replicated volumes, and instructs the array controller 230 to make it so. For example, it is supposed that primary volume 134 will be split from secondary volume 135 at a certain time T.

The array controller 230 receives this instruction, and clears the replicated volume number 135 of volume 134 from the volume management table 400 (801).

Next, the management computer 19 instructs the agent program 360 on computer 10 to split volume 134 from the virtual removable drive (803).

The agent program 360 notifies the application 399 that volume 134 is to be split (805).

If the application 399 refuses this request, a notification to this effect is sent to the management computer 19, and splitting fails (809).

When the application 399 approves the split, the agent program 360 instructs the file system to eject volume 134 (811).

Upon receiving an ejection request, the file system clears all data from inside the buffer and cache [memories] of the file system (813), and next, the removable device driver 310 issues an eject command (in SCSI, a bit for ejecting is set in the START STOP UNIT command) to the array controller 230 (815).

Upon receiving the eject command, the array controller 230 references the volume management table 400, and confirms that it is a request to split volume 135 (that replicated volume number “135” has been cleared from the volume management table 400), and releases the connection between volume 134 and 135 by the replicating unit 155 (817).

In addition, array controller 230 holds the time at which the volume connection was released in the volume management table 400 (818).

The array controller 230 reports the completion of ejection to the removable device driver 310 of computer 10 (819), but volume 134 is in the state of being loaded onto virtual removable drive 110 as-is (the virtual removable drive number remains “134”).

The removable device driver 310 reports to the file system that ejection has been completed (821), and the file system reports to the agent program 360 that ejection has been completed (823).

The agent program 360 notifies the application 399 that volume 134 has been reloaded (824).

When the management computer 19 receives notification from the agent program 360 that splitting is complete (825), it reads out the volume management table 400 via the management module 190, and confirms that volume 135 has been split (827).

Further, the disk array apparatus 100 updates the setup screen 410 on the basis of the volume management table 400 (829). The time at which splitting was carried out is displayed on the setup screen.

Furthermore, a write protect flag can also be set as needed.

As described hereinabove, the primary-secondary splitting of replicated volumes between volume 134 and volume 135 can be carried out more readily, and the problem of not being able to use the split volumes in an incomplete condition can be done away with. In addition, secondary volume 134 can also be made good use of as backup at the time primary volume 135 is split.

Furthermore, since volume 135 is in the file system A format, it can also be used from computer 11. Thus, adding replicated file system type information to a replicated volume makes it possible to determine which computer is capable of using the replicated volume. Further, if a write protect flag has been set, simultaneous use from computers 10 and 11 is possible.

File System Type Detecting Variations

Furthermore, in the above-described embodiment, the detection of file system types is carried out by the agent program 360 on the host computer, but [this detection] can also be carried out by a file system identifying unit 151 disposed in the array controller 230 of the disk array apparatus 100.

The file system identifying unit 151 regularly searches the contents of volumes inside the disk array apparatus, retrieves data strings set beforehand via the management module, and, based on these search results, identifies the types of file systems.

In this case, utilizing file system identifying means provided in the disk array apparatus eliminates the need for carrying out development, corresponding to multiple OS, of software for identifying file systems.

Loading Process Variation for Management Module

In the above-mentioned embodiment, the volume management table 400 was used to describe which volume gets loaded onto a virtual removable drive. As a separate method, an SCSI command-defined MOVE command can also be used via the FC interface module. In a MOVE command, which media are to be loaded onto which drives can be specified as element numbers by the application and the management computer 19 GUI. The virtual removable drive numbers and volume numbers indicated in the above-mentioned embodiment can be utilized as element numbers.

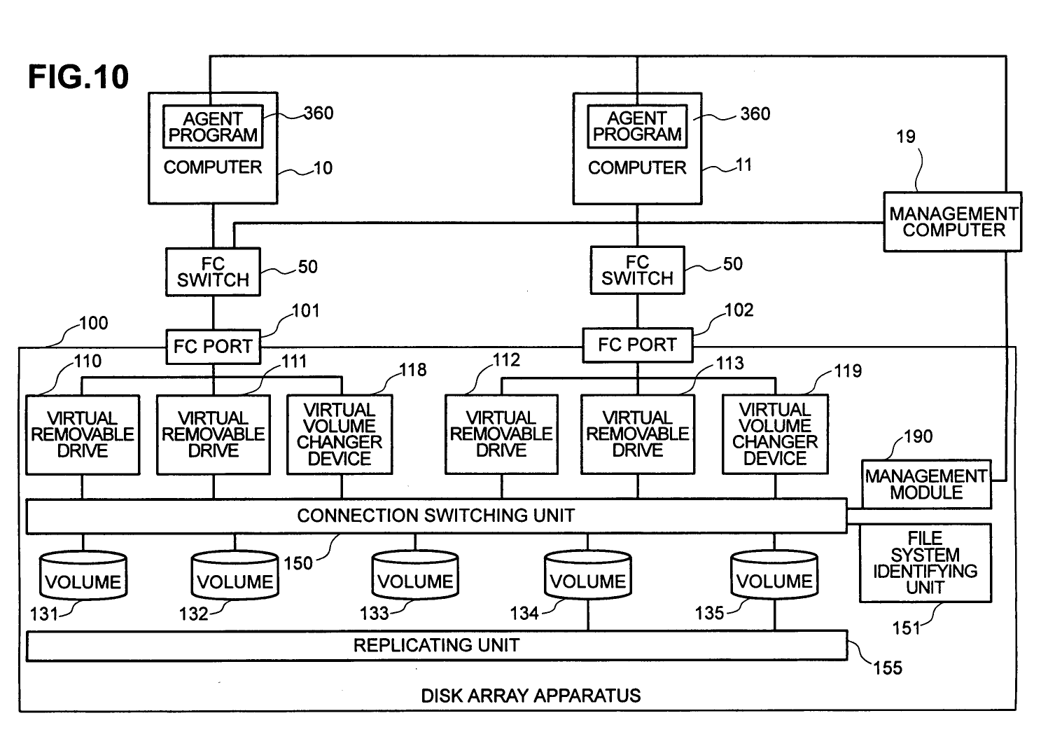

To use a MOVE command, the management computer 19 is connected to the FC switches 50 as shown in FIG. 10.

Virtual volume changer devices 118 and 119 are disposed in FC ports 101 and 102 in the disk array apparatus 100.

The virtual volume changer devices 118 and 119 are realized as management programs executed inside the array controller 230.

Upon receiving a MOVE command, the array controller 230 updates the volume management table 400 on the basis of the element numbers specified in the command.

Accordingly, connecting and switching volumes by assigning identifiers (element numbers) to the volumes and virtual removable drives makes it possible to connect and switch volumes using an SCSI MOVE command.

In the above-mentioned embodiments of the present invention, managing volumes in accordance with a volume management table 400 showing the relationships between virtually loaded drives and volumes means that mounting is not carried out for all volumes, even in a computer that uses a disk array apparatus having several thousand volumes.

Therefore, it is possible to reduce the amount of occupied memory required when mounting a volume, and it is also possible to shorten computer startup time.

In a connecting apparatus (for example, an FC switch 50) for managing the correspondent relationships between computers 10, 11 and a data storage apparatus 100, a constitution for realizing functions realized by the management unit 250 of the above-described disk array apparatus 100 can also be employed.

According to the present invention, it is possible to provide a constitution, programs and a method for achieving a data storage apparatus (or a group of data storage apparatus in a SAN) having several thousand volumes in a data storage system having a data storage apparatus and a computer.

What is claimed is:

1. A data storage system having a computer and a data storage apparatus, which has a plurality of storage volumes for storing data to be accessed by said computer, wherein:
said data storage apparatus comprises:
a management unit for sending a response to said computer for recognizing a virtual drive unit capable of treating said storage volume that is non-removable as a removable storage medium; and
a storing unit for storing volume management information indicating the correspondent relationship between said virtual drive unit and said storage volume, and
said computer comprises:
an interface for receiving said response; and
a management unit for recognizing said virtual drive unit based on said response, and
the management unit of said data storage apparatus specifies said storage volume to be accessed based on an access request from said computer to said virtual drive unit, and said volume management information.

2. The data storage system according to claim 1, wherein:
the management unit of said computer further recognizes said storage volume corresponding to said virtual drive unit as a real non-removable storage volume.

3. The data storage system according to claim 1, wherein:
the management unit of said data storage apparatus receives a switching request from said computer for switching the correspondent relationship between said virtual drive unit and said storage volume, and, based on said switching request, rewrites said volume management information.

4. The data storage system according to claim 1, wherein:
the management unit of said computer sends to said management computer the file system type information of said virtual drive unit recognized on the basis of said response.

5. The data storage system according to claim 1, wherein:
the management unit of said data storage apparatus sends to said management computer the file system type information of said virtual drive unit recognized on the basis of said response.

6. The data storage system according to claim 1, wherein:
the storing unit of said data storage apparatus further stores, as said volume management information, replication information for replicating information stored in a first storage volume of said storage volumes, in a second storage volume, and
the management unit of said data storage apparatus replicates the information stored in the first storage volume of said storage volumes, in the second storage volume on the basis of said replication information, and when a request is issued from said computer for retrieving said first storage volume from a virtual drive unit, said management unit treats said second storage volume as a replicated storage volume at the time at which said first storage volume split from the virtual drive unit, by terminating replication of information stored in said first storage volume to said second storage volume.

7. A data storage apparatus having a plurality of storage volumes for storing data to be accessed by a computer, comprising:
a management unit for sending a response to said computer for recognizing a virtual drive unit capable of treating said storage volume that is non-removable as a removable storage medium; and
a storing unit for storing volume management information indicating the correspondent relationship between said virtual drive unit and said storage volume, wherein:
said management unit specifies said storage volume to be accessed based on an access request from said computer to said virtual drive unit, and said volume management information.

8. A computer for accessing data stored in a plurality of storage volumes in a data storage apparatus, comprising:
an interface for receiving a response from said data storage apparatus for recognizing a virtual drive unit capable of treating said storage volume that is non-removable as a removable storage medium; and
a management unit for recognizing said virtual drive unit based on said response.

9. A connecting apparatus for managing the correspondent relationship between a computer and a data storage apparatus having a plurality of storage volumes for storing data to be accessed by said computer, comprising:
a management unit for generating a response to said computer for recognizing a virtual drive unit capable of treating said storage volume that is non-removable as a removable storage medium; and
a storing unit for storing volume management information indicating the correspondent relationships between said virtual drive unit and said storage volumes, wherein:
said management unit specifies said storage volume to be accessed based on an access request from said computer to said virtual drive unit, and said volume management information.

10. A program for managing access to data stored in a plurality of storage volumes in a data storage apparatus, said program causing a computer to execute:
function for receiving a response from said data storage apparatus for recognizing a virtual drive unit capable of treating said storage volume that is non-removable as a removable storage medium; and
function for recognizing, on the basis of said response, a virtual drive unit to which said storage volume that is non-removable is connected as a removable storage medium.

11. A program for managing access to data stored in a plurality of storage volumes in a data storage apparatus, said program causing a computer to execute:
function for generating a response to said computer for recognizing a virtual drive unit capable of treating said storage volume that is non-removable as a removable storage medium;
function for storing volume management information indicating the correspondent relationship between said virtual drive unit and said storage volume; and
function for specifying said storage volume to be accessed based on an access request from said computer to said virtual drive unit, and said volume management information.

12. A method for managing access to data stored in a plurality of storage volumes in a data storage apparatus, comprising the steps of:
receiving a response from said data storage apparatus for recognizing a virtual drive unit capable of treating said storage volume that is non-removable as a removable storage medium; and
recognizing, on the basis of said response, a virtual drive unit to which said storage volume that is non-removable is connected as a removable storage medium.

13. A method for managing access to data stored in a plurality of storage volumes in a data storage apparatus, comprising the steps of:
generating a response to said computer for recognizing a virtual drive unit capable of treating said storage volume that is non-removable as a removable storage medium;
storing volume management information indicating the correspondent relationship between said virtual drive unit and said storage volume; and
specifying said storage volume to be accessed based on an access request from said computer to said virtual drive unit, and said volume management information.
